(19) United States
(12) Patent Application Publication
(10) Pub. No.: US 2018/0228335 A1
(43) Pub. Date: Aug. 16, 2018

(54) ROBOTIC VACUUM CLEANER DOCKING STATION WITH DEBRIS REMOVAL

(71) Applicant: Kenneth C. Miller, Aptos, CA (US)

(72) Inventor: Kenneth C. Miller, Aptos, CA (US)

(21) Appl. No.: 15/892,672

(22) Filed: Feb. 9, 2018

Related U.S. Application Data
(60) Provisional application No. 62/457,234, filed on Feb. 10, 2017.

(51) Int. Cl. A47L 11/40; A47L 5/38; A47L 5/14; B60L 11/18

(52) U.S. Cl. CPC A47L 11/4025; A47L 5/38; A47L 2201/024; B60L 11/1809; A47L 2201/022; A47L 5/14

(57) ABSTRACT

A docking system for a robotic vacuum is provided that includes a debris disposal chamber on a docking station. An actuation feature is used to couple the debris disposal chamber to a debris collection chamber on the robotic vacuum. A gas pressure differential source or a mechanical wand removes collected debris from the robotic vacuum debris collection chamber into the docking station debris disposal chamber.

### RELATED APPLICATIONS

This application is a non-provisional application that claims priority benefit of U.S. Provisional Application Ser. No. 62/457,234 filed Feb. 10, 2017; the contents of which are hereby incorporated by reference.

### FIELD OF THE INVENTION

The present invention in general relates to vacuum cleaners, and in particular to an automated docking station that removes collected debris from a robotic vacuum.

### BACKGROUND OF THE INVENTION

Robotic vacuum cleaners are autonomous, self-propelled vacuum cleaners with intelligent programming that tracks the path of the vacuum to ensure the complete coverage of an area to be cleaned. Robotic vacuum cleaners employ impact sensors to detect obstacles including walls and furniture, and adjust their progression in response to the detected obstacle. Robotic vacuum cleaners typically use spinning brushes to reach tight corners and operate on rechargeable batteries. Many robotic vacuum cleaners are also programmed to return to a charging or docking station when the room to be vacuumed has been completed or if the vacuum batteries are nearly depleted. Robotic vacuum cleaners may also combine a number of cleaning features including mopping, and ultra-violet (UV) sterilization simultaneous to vacuuming.

Robotic vacuum cleaners have gained wide acceptance due to their relatively small size and ability to clean without user intervention. However, since robotic vacuum cleaners need to be quite small to move around obstacles, the robotic vacuum cleaners often have limited capacity to store the debris that has been collected, requiring frequent human intervention/servicing to manually remove the collected and stored debris.

Thus, there exists a need to effectively increase the storage capacity of robotic vacuum cleaners by increasing the time interval between required human intervention to manually remove the collected and stored debris.

### SUMMARY OF THE INVENTION

A docking system for a robotic vacuum is provided that includes a debris disposal chamber on a docking station. An actuation feature is used to couple the debris disposal chamber to a debris collection chamber on the robotic vacuum. A gas pressure differential source or a mechanical wand removes collected debris from the robotic vacuum debris collection chamber into the docking station debris disposal chamber.

### BRIEF DESCRIPTION OF THE DRAWINGS

The present invention is further detailed with respect to the following drawings that are intended to show certain aspects of the present of invention, but should not be construed as limit on the practice of the invention, where like numbers have the same meaning in the different drawing views, and wherein:

FIG. 1A is a side view of an embodiment of a robotic vacuum cleaner operative in the present invention;

FIG. 1B is a bottom view of the robotic vacuum cleaner shown in FIG. 1A;

FIG. 2A is a side view of an embodiment of a docking station operative with robotic vacuums having a bottom mounted discharge door in accordance with the present invention;

FIG. 2B is a top view of the embodiment of the docking station of FIG. 2A operative in the present invention;

FIG. 3A is a side view of an embodiment of a docking station operative with robotic vacuums having a side mounted discharge door in accordance with the present invention;

FIG. 3B is a top view of the embodiment of the docking station of FIG. 3A operative in the present invention; and

FIG. 4 is a perspective view of a debris container that may be used with embodiments of the inventive docking station.

### DETAILED DESCRIPTION OF THE INVENTION

The present invention has utility as a docking station able to automatically remove collected debris from a robotic vacuum cleaner without human intervention.

Some embodiments of the inventive docking station may store up to one hundred times (100×) the amount of collected debris that may be stored in the robotic vacuum itself. Various robotic vacuum cleaners may be directly compatible with embodiments of the inventive docking station or through the use of a customized adapter. Robotic vacuum cleaners may be programmed to return to embodiments of the docking station when the room or area to be vacuumed has been completed, the debris collection bin of the vacuum is full, or if the vacuum batteries are nearly depleted. Embodiments of the inventive docking station may be used to recharge the batteries of the robotic vacuum. In a specific embodiment the inventive docking station may itself be mobile and move to one or more robotic vacuums that need to be emptied of collected debris or require a recharge.

Some embodiments of the inventive docking station draw a suction to remove collected and stored debris from the robotic vacuum. The suction may be created by a motor driven fan or via connection to an in-house vacuum system. In a specific inventive embodiment, the robotic vacuum cleaner uses the vacuum cleaner motor, which is used to suction debris into the collection bin, to also blow out debris from the vacuum into a collection port of the docking station. During the docking of a robotic vacuum cleaner, the docking station may actuate a selectively fastener illustratively including a lever, button, or switch which opens a discharge door of the debris collection chamber of the robotic vacuum. The docking station may actively actuate the lever, button, or switch to open the discharge door of the collection bin of the robotic vacuum, or a molded feature in an area of the docking station that receives the robotic vacuum may passively press against the lever, button, or switch to open the discharge door of the collection bin of the robotic vacuum. In still other inventive embodiments, the docketing station uses a positive pressure air flow to blow debris from the collection bin, while in still other embodiments, a mechanical wand in the form of a hook, spiral, or other shape physically engages the debris mass and pulls the same from the collection bin.

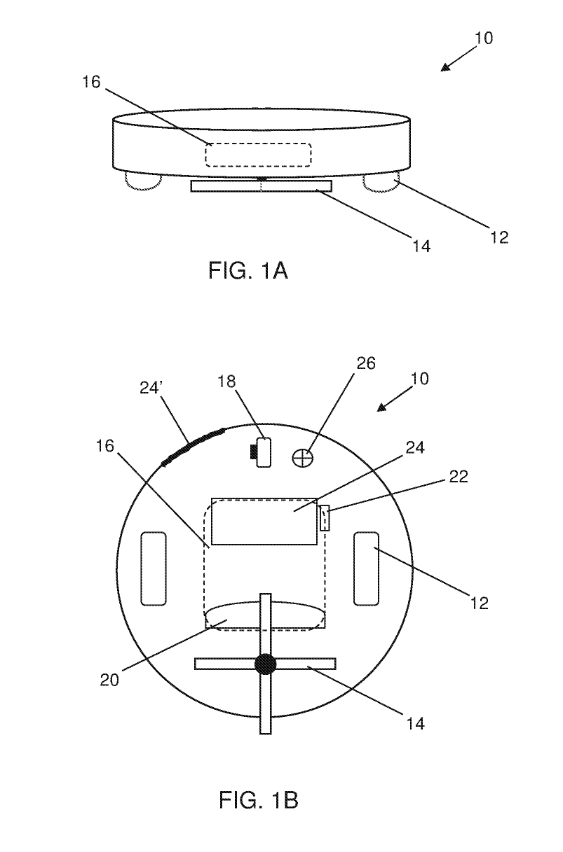

Referring now to the figures, FIGS. 1A and 1B are a side view and bottom view, respectively of an embodiment of a robot vacuum cleaner 10 that may be propelled and steered by drive wheels 12 with caster wheel 18 that is free to turn. The spinning brushes 14 sweep debris into a collection chamber 16 via input port 20. Lever, button, or switch 22 opens a discharge door 24 of the debris collection chamber 16 of the robotic vacuum 10. In an embodiment the discharge door 24′ may be mounted on the side of the vacuum 10.

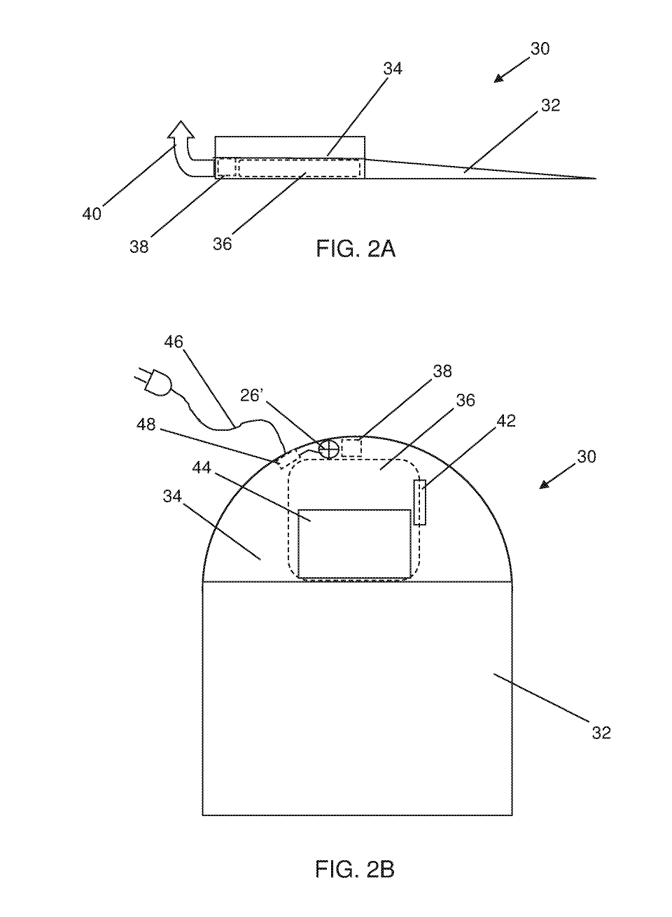

FIGS. 2A and 2B are a side view and top view, respectively of an embodiment of a docking station 30. A ramp 32 leads to a platform 34 the top of the docking station 30. In operation a robotic vacuum cleaner illustratively including the robot vacuum cleaner 10 of FIGS. 1A and 1B proceeds up the ramp 32 and rotates until charging contact 26 on the vacuum 10 aligns with the charging sensor 26′ on the platform 34. Actuation feature 42 on the platform 34 presses the lever, button, or switch 22 that opens the discharge door 24 of the debris collection chamber 16 of the robotic vacuum 10 when positioned over the now opened disposal door 44 that control access to the collection port of the disposal chamber 36 beneath the platform 34. Electrical power (AC-alternating current) is supplied via cord 46, and AC/DC transformer 48 converts the power to direct current (DC) for charging the rechargeable batteries of the vacuum 10. Blower motor 38 sucks in debris from the debris collection chamber 16 into the disposal chamber 36. In a specific embodiment an in-house vacuum system connected via hose 40 sucks the collected debris from the robotic vacuum 10. It is appreciated that the hose 40 may also be attached to urge pressurized air into the chamber 36 to empty the collected debris therefrom. A suction source and a pressurized air source are collectively referred to herein as a gas pressure differential source.

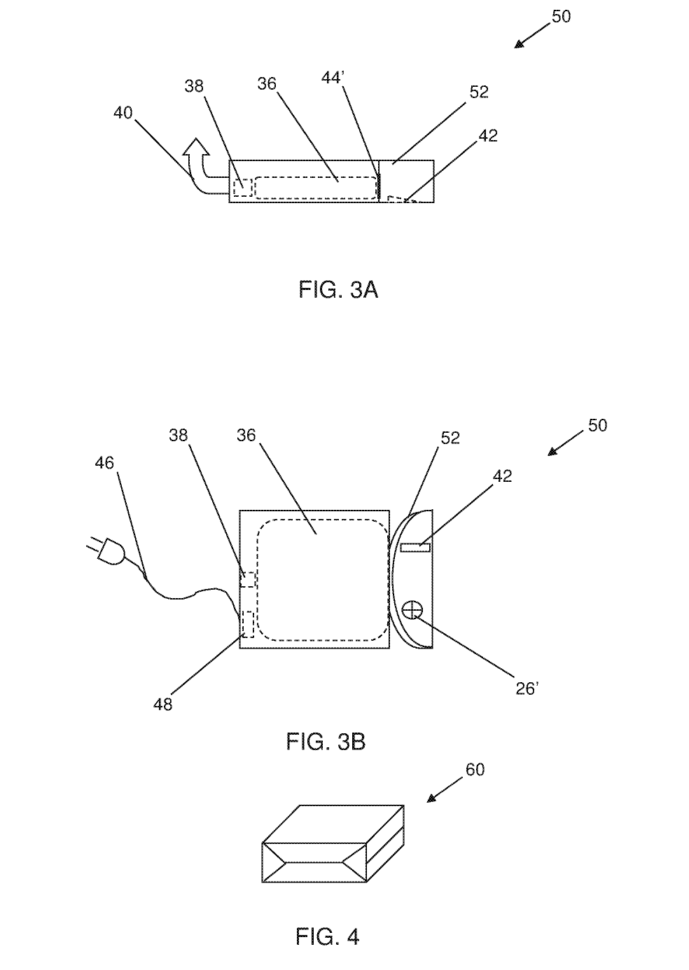

FIGS. 3A and 3B are a side view and top view, respectively of an embodiment of a docking station 50 operative with robotic vacuums having a side mounted discharge door 24′ as best shown in FIG. 1B. In operation a robotic vacuum cleaner illustratively including the robot vacuum cleaner 10 of FIGS. 1A and 1B having a side mounted discharge door 24′ backs into the backstop 52 of docking station 50 and rotates and aligns with the charging sensor 26′. Actuation feature 42 presses the lever, button, or switch 22 that opens the side mounted discharge door 24′ of the debris collection chamber 16 of the robotic vacuum 10 when positioned in front of the now opened side disposal door 44′ of the disposal chamber 36 of the docking station 50. Electrical power (AC-alternating current) is supplied via cord 46, and AC/DC transformer 48 converts the power to direct current (DC) for charging the rechargeable batteries of the vacuum 10. Blower motor 38 sucks in debris from the debris collection chamber 16 into the disposal chamber 36. In a specific inventive embodiment, an in-house vacuum system connected via hose 40 sucks the collected debris from the robotic vacuum 10.

In an inventive embodiment debris collected by a robotic vacuum 10 may be stored in a debris storage container 60 as shown in FIG. 4. Embodiments of the debris storage container may be disposable and/or collapsible. The debris storage container 60 may be offloaded from the robotic vacuum 10 into embodiments of the docking station (30, 50) through the discharge door 24 or the side mounted discharge door 24′. In a similar manner to a vacuum bag, the debris storage container 60 may be collapsible allowing for multiple unfilled debris storage containers 60 to be stored in a collapsed state in the robotic vacuum 10. The robotic vacuum cleaner may be able to automatically load an empty debris storage container 60 into a collection position and determine when the debris storage container 60 has been filled and requires the filled debris storage container 60 to be deposited in the docking station (30, 50). The docking station (30, 50) may act as a trash compactor and compress the deposited filled debris containers 60 to more efficiently store and utilize the disposal chamber 36 of the docking station (30, 50). In a similar manner to the operation of the robotic vacuum 10, the docking station (30, 50) may contain two or more empty and collapsed storage containers 60, where the docking station (30, 50) may be able to automatically load an empty debris storage container 60 into a collection position and determine when the debris storage container 60 has been filled and requires the filled debris storage container 60 to be moved away from the disposal door 44 and a new unfilled debris storage container 60 put in place to collect debris.

The foregoing description is illustrative of particular embodiments of the invention, but is not meant to be a limitation upon the practice thereof.

1. A docking system for a robotic vacuum comprising:
a debris disposal chamber on a docking station;
an actuation feature couples said debris disposal chamber to a debris collection chamber on said robotic vacuum; and
a gas pressure differential source or a mechanical wand for removal of collected debris from said robotic vacuum debris collection chamber into said docking station debris disposal chamber.

2. The system of claim 1 wherein said docking station further comprises a transformer that converts alternating current to direct current for charging a set of batteries on said robotic vacuum.

3. The system of claim 1 wherein said gas pressure differential source is a blower motor.

4. The system of claim 1 wherein said gas pressure differential source is an in-house vacuum system connected via a hose.

5. The system of claim 1 wherein said docking station stores up to one hundred times (100×) of the collected debris.

6. The system of claim 1 wherein said docking station is mobile and moves to one or more of said robotic vacuums in need to be emptied of collected debris or require a battery recharge.

7. The system of claim 1 wherein said robotic vacuum is programmed to return to said docking station when at least one condition has been met of: an area to be vacuumed has been completed, a debris collection chamber of said robotic vacuum is full, or if a set of batteries of said robotic vacuum batteries are nearly depleted.

8. The system of claim 1 further comprising a debris storage container.

9. The system of claim 8 wherein the debris storage container is collapsible and disposable.

10. The system of claim 8 wherein the robotic vacuum has a plurality of unfilled debris storage containers in a collapsed state, and the robotic vacuum automatically loads an empty debris storage container into a collection position on said robotic vacuum and determines when the debris storage container has been filled and requires the filled debris storage container to be deposited in the docking station.

11. The system of claim 8 wherein the docking station has a plurality of unfilled debris storage containers in a collapsed state, and the docking station automatically replaces a full debris storage container with an empty debris storage container into a collection position on said robotic vacuum.

12. The system of claim 8 wherein the docking station has a plurality of unfilled debris storage containers, and the docking station automatically replaces a full debris storage container with an empty debris storage container into a collection position on said robotic vacuum.

13. The system of claim 11 further comprising a compactor in the docking station to compress the filled debris storage containers.

14. The system of claim 1 wherein a charging contact on said docking station aligns with a complimentary charging contact on said robotic vacuum.

15. The system of claim 1 wherein further comprising a ramp terminating in a platform accessible to said robotic vacuum.

16. The system of claim 15 wherein said actuation feature is adapted to engage said robotic vacuum on said platform.

17. The system of claim 1 wherein said actuation feature is adapted to press a lever, a button, or a switch to access said debris disposal chamber.
